(19) United States
(12) Patent Application Publication
(10) Pub. No.: US 2012/0291878 A1
(43) Pub. Date: Nov. 22, 2012

(54) COMPOSITE TANK, AND ASSEMBLY INCLUDING SUCH A TANK AND MEMBER FOR RECEIVING AND/OR DISPENSING GAS

(75) Inventors: Philippe Pisot, Apprieu (FR); Antoine Frenal, Ezanville (FR); Tristan Debry, Rennes (FR)

(73) Assignee: L'AIR LIQUIDE, SOCIETE ANONYME POUR L'ETUDE ET L'EXPLOITATION DES PROCEDES GEORGES CLAUDE, Paris (FR)

(21) Appl. No.: 13/575,399

(22) PCT Filed: Jan. 28, 2011
(86) PCT No.: PCT/FR2011/050170

§ 371 Date: Jul. 26, 2012

(30) Foreign Application Priority Data
Feb. 11, 2010 (FR) 1050984

(51) Int. Cl. F17C 1/02; F16K 43/00

(52) U.S. Cl. 137/315.01; 220/586

(57) ABSTRACT

The invention relates to a composite pressurized gas tank including a sealed inner casing (12), comprising an opening (18) on one of the ends of the casing, and a base (13) attached to the opening (18) of the inner casing (12), the base (13) being provided so as to receive or have built therein a valve or faucet, the tank also including an outer mechanical reinforcement casing (11) that is placed on at least a portion of the inner casing (12). Said tank is characterized in that at least a portion of the gap (14), located between the inner casing (12) and the outer mechanical reinforcement casing (11), is connected to at least one area (15) for collecting the gas capable of accumulating in said gap (14). The at least one collecting area (15, 137) leads into a predetermined discharge area (16, 26, 23) that is located outside the gap (14).

### CROSS REFERENCE TO RELATED APPLICATIONS

This application is a 371 of International PCT Application PCT/FR2011/050170, filed Jan. 28, 2011, which claims priority to FR Application 1050984, filed Feb. 11, 2010, the entire contents of which are incorporated herein by reference.

### BACKGROUND

The present invention relates to a composite tank, as well as an assembly comprising a member for receiving and/or dispensing gas and such a tank.

The invention relates more particularly to a composite pressurized gas tank comprising a sealed internal casing having an opening at one of its ends, a base fixed in the region of the opening of the internal casing, the base being provided to receive or incorporate a valve or faucet, the tank also comprising an external mechanical reinforcement casing arranged on at least one part of the internal casing.

Applications which require the storage of gas use the technology of composite materials to provide an excellent compromise between the mass of the outer packaging and the mass of the stored gas. For example, so-called “type IV” tanks or bottles of gas made of composite materials comprise:
a sealed internal casing (also called a “liner”) consisting, for example, of plastics and generally a polymer material such as polyamide, the function thereof being to provide the seal of the outer packaging relative to the type of gas stored,
an external mechanical reinforcement casing (generally made of carbon fibers immersed in epoxy-type resin). Said external casing or layer does not have to be sealed but current manufacturing processes do not allow this to be perfectly controlled. As a result, said external casing which is generally obtained by winding, may be sealed uniformly or locally,
a (generally metal) base, the function thereof being to permit the connection of the bottle to a valve or faucet (either with or without integrated pressure relief) providing the fluidic connection with the consumer application point for the gas of the tank.

Reference may be made, for example, to FR2744517A1 or EP2000734A2 or US2007012551A1 or US2009071930A1.

Even if said tanks are designed as sealed, during a specific period of storage a certain quantity of gas is liable to pass through the internal casing to the outside. In particular, when the gas contains small molecules, such as for example helium or hydrogen, and the storage pressure is raised (for example from 450 bar to 800 bar) a certain quantity of gas passes through the internal casing. Said gas is trapped in the gap located between the internal casing and the external mechanical reinforcement casing.

The pressure at which said gas is trapped in the gap in certain cases may be equal to the storage pressure in the internal casing (said pressure of the trapped gas depends on various parameters, including the difference in the permeation flow between the internal casing and the external mechanical reinforcement casing).

The time required for emptying a tank is generally much less than the time required for reverse permeation (return) of the quantity of trapped gas from the gap toward the interior of the tank. As a result, when emptying the tank, a difference in pressure may be created between the gap and the interior of the tank. Said difference in pressure mechanically stresses the sealed internal casing toward the interior of the tank. Said sealed internal casing is not designed to resist said stresses and blistering may thus be formed in the interior of the tank. The volume of said blistering permits the pressure of the trapped gas to be reduced until it finds a mechanical equilibrium. The successive filling and emptying of the tank may lead to the occurrence of fatigue and premature wear of the sealed internal casing on the periphery of the blistering of the bottle (for example folds forming fissures). This reduces the life of the tank and, should this happen, may cause dangerous leaks.

An object of the present invention is to remedy all or some of the drawbacks of the prior art set forth above.

### SUMMARY

To this end, the tank according to the invention and according to the generic definition provided by the preamble above, is essentially characterized in that at least one part of the gap located between the internal casing and the external mechanical reinforcement casing is connected to at least one collecting zone for the gas which is capable of accumulating in said gap, the at least one collecting zone opening into a specific evacuation zone outside the gap.

The invention also makes it possible to resolve or alleviate said problem of blistering by avoiding gas being trapped between the fiber reinforcement and the sealed internal casing.

The invention is able to permit the drainage or even the controlled collection of gas as a result of permeation from the sealed internal casing.

Moreover, embodiments of the invention may comprise one or more of the following features:
the evacuation zone comprises the atmosphere,
the evacuation zone comprises the internal volume of the internal casing, the at least one collecting zone opening into the internal volume of the internal casing via a pressure-sensitive flap valve and permitting the passage of gas toward the internal volume of the internal casing solely in the event of a specific difference in pressure between the at least one collecting zone and the internal volume of the internal casing,
the evacuation zone comprises at least one conduit and/or cavity delimited by the base,
the base comprises an upper part of generally tubular shape and a lower portion, one part of the surface of the internal casing being in sealed contact with at least one part of a surface of the lower portion of the base,
at least one collecting zone is formed in the region of the external surface of the portion of the internal casing which is located in the region of the base;
at least one collecting zone is formed in the region of an external surface of the base,
the at least one collecting zone comprises at least one groove forming at least one collecting and circulation channel for the gas,
the collecting zone communicates with at least one volume located inside the body of the base and provided to receive a valve or a faucet,
the tank comprises a faucet, with or without a pressure relief member, arranged in a sealed manner in the base,
the evacuation zone comprises at least one volume located between the body of the base and the body of the faucet arranged in the base, said volume being in fluidic communication with the collecting zone,
the evacuation zone comprises a volume or a channel inside the body of the faucet,
the evacuation zone comprises an internal evacuation circuit in the body of the faucet, the internal evacuation circuit being in fluidic communication with the collecting zone,
the faucet comprises an internal extraction circuit and/or an internal filling circuit in fluidic communication with the internal volume of the internal casing, the internal evacuation circuit of the faucet being at least partially separate from the extraction circuit and/or the filling circuit,
the tank is a tank of the IV type,
the assembly between the internal casing and the base is sealed,
the internal casing consists of polymer such as polyimide,
the base comprises or consists of at least one of the following materials: a metal material, an aluminum alloy (for example 7000 series), steel, for example of the 350D4 type, stainless steel, for example of the AISI 316L type, etc.),
the mechanical reinforcement layer comprises a resin, for example of the epoxy type, and fibers such as carbon fibers,
at least one part of the groove(s) is(are) longitudinal, i.e. oriented in a direction parallel or substantially parallel to the longitudinal axis of the tank,
the volume located between the body of the base and the body of the faucet and forming at least one part of the evacuation zone is delimited by at least one seal isolating said volume from the interior of the internal casing,
the volume located between the body of the base and the body of the faucet and forming at least one part of the evacuation zone is delimited by at least one seal isolating said volume from the ambient air outside the faucet,
a layer of drainage material is arranged at least locally between the internal casing and the reinforcing layer to delimit a gap of specific thickness,
the layer of drainage material comprises at least one of the following: a polyurethane foam, non-impregnated mineral and/or synthetic fibers,
one end of the internal casing is sandwiched in the thickness of the base.

The invention also relates to an assembly for delivering gas comprising a tank according to any one of the features above or below and a member for receiving and/or dispensing gas, comprising an end for selective connection to the faucet to provide a transfer of gas to or from the tank via the faucet in which the member comprises a circuit for recovering gas which communicates selectively with the evacuation zone when the member is connected to the faucet.

### BRIEF DESCRIPTION OF THE DRAWINGS

The invention may also relate to any device or alternative method having any combination of the features above or below.

Further particularities and advantages will appear from reading the following description, made with reference to the figures, in which:

FIG. 1 shows a view in longitudinal section of a first embodiment of a tank according to the invention provided with a faucet,

FIG. 2 shows a view in section of a detail of the upper part of the tank of FIG. 1 in which a member for receiving gas is connected to the faucet of the tank,

FIGS. 3 to 5 show in schematic and simplified form the structure and operation of, respectively, three embodiments according to the invention of the assembly comprising a tank, a faucet, and a receiving member,

FIG. 6 shows a sectional view of a detail of a second embodiment according to the invention of a tank provided with a faucet and connected to a receiving member,

FIG. 7 shows a sectional view of a detail of a third embodiment according to the invention of a tank provided with a faucet which is connected to a receiving member,

FIG. 8 shows a sectional view of a detail of a fourth embodiment according to the invention of a tank provided with a faucet connected to a receiving member.

### DESCRIPTION OF PREFERRED EMBODIMENTS

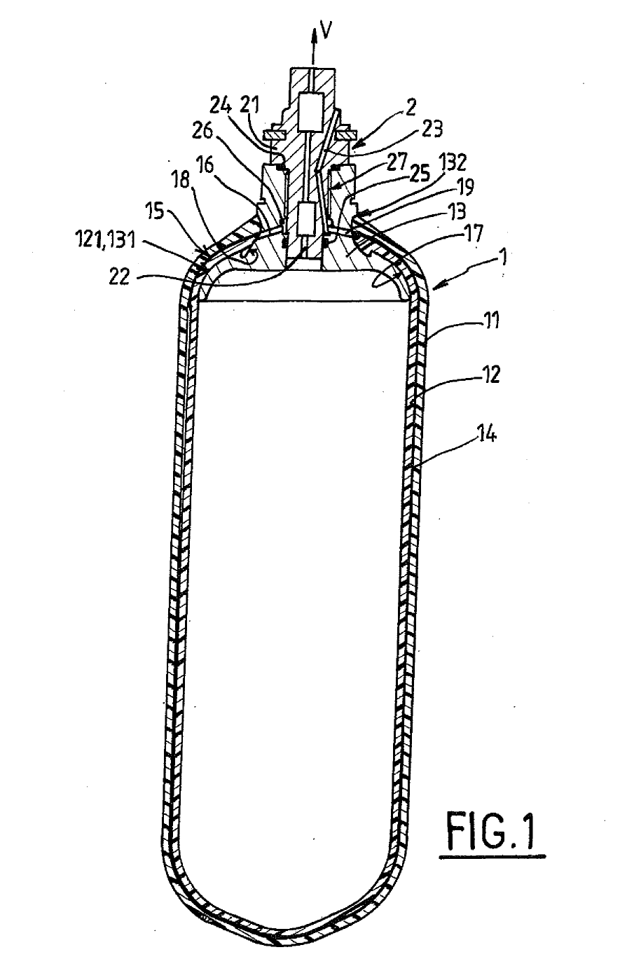

FIG. 1 illustrates a composite pressurized gas tank 1. Preferably, the tank (which may also be denoted by the term “bottle”) is a composite tank of the IV type.

The tank 1 comprises a sealed internal casing 12 (also called a “liner”) having an opening 18 at one of its ends. The sealed internal casing 12 has, for example, an oblong shape. The opening 18 is, for example, circular.

A base 13, for example made of metal, is fixed in the region of the opening 18 of the internal casing 12. The base 13 is conventionally provided to receive or incorporate a valve or a faucet. An external mechanical reinforcement casing 11 is, moreover, arranged on at least one part of the external surface of the internal casing 12 (and preferably over its entire surface). For example, the external mechanical reinforcement casing 11 comprises fibers and a resin. The thickness of the external mechanical reinforcement casing 11 may be adapted according to the storage pressure of the gas. In the present text, the external casing 11 may also be denoted “external layer” or “reinforcement layer”.

A “simple” faucet 2 or a faucet with integrated pressure relief is removably mounted in the base (naturally it is possible to conceive that the faucet 2 is formed integrally with the base 13). For reasons of simplification of the figures, the faucet 2 is shown partially and in simplified form.

A sealed contact is made between the internal surface 121 of the internal casing 12 and the external surface 131 of the base 13. Said sealed contact may be implemented, for example, via a connecting element 17 such as adhesive, a seal, or any other appropriate means.

As shown, the external reinforcement layer 11 may extend and cover the lower part 132 of the base 13 (which is preferably flared).

The resin of the external casing 11 is wetted and bonded to the metal base 13. The corresponding connection between the external mechanical reinforcement casing 11 and the metal base 13 is thus sealed.

The gap 14 located between the external mechanical reinforcement casing 11 and the internal casing 12 is capable of trapping the gas as a result of permeation from the internal casing 12.

According to one advantageous particularity of the invention, at least one part of the gap 14 communicates directly or indirectly with at least one collecting zone 15 for gas capable of accumulating in said gap 14. Moreover, the at least one collecting zone 15 opens into a specific evacuation zone 16, 26, 23 outside the gap 14 (a secure zone).

The collecting zone 15 and the evacuation zone 16, 26, 23 may be dimensioned according to the maximum expected permeation flow for the sealed internal casing 12. Said permeation flow is a function of, in particular:
the nature and the pressure of the stored gas,
the material forming the internal casing 12 and its surface in contact with the gas.

Said collection and said evacuation of gas make it possible to avoid premature wear of the tank. The quantity of gas collected may also be measured in order to evaluate the state of the internal casing.

For example, the collecting zone comprises grooves 15. In the example of FIG. 1, the gap 14 opens into the grooves 15, which are for example longitudinal, formed on the external surface of the internal casing 12.

Collecting grooves 15 may, in particular, be located in the region of the zone of the internal casing 12 which is confined (fixed) between the base 13 and the reinforcing layer 11.

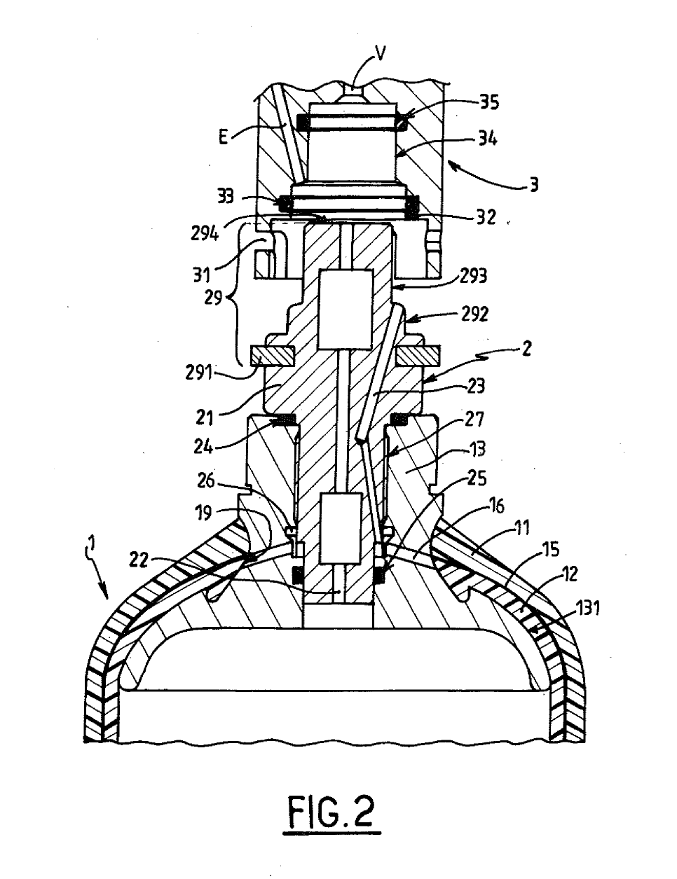

Said grooves 15, which communicate with the gap 14, thus make it possible to convey the gas trapped in the gap 14 to an external evacuation zone. The evacuation zone may, for example, simply be the outside (ambient atmosphere around the tank). When the gas is inflammable or dangerous, the evacuation zone preferably recovers the gas in a more secure manner. For example, as shown in FIGS. 1 and 2, the collecting grooves 15 may open into an annular cavity 19 located at the end of the circular opening 18 of the casing 12.

The annular cavity 19 is, for example, connected to one or preferably several orifices or conduits 16 formed in the base 13.

The orifices 16 may open into and communicate in the central zone of the base 13 where a faucet 2 is fixed. For example, the faucet 2 is fixed in the base by screwing, by means of a system comprising a thread 27 and a tapped portion.

The orifices 16 converge, for example, toward a chamber 26 located between the metal base 13 and the faucet 2. The chamber 26 has, for example, an annular shape. The chamber 26 may be delimited in a sealed manner in the lower part by a first seal 25 which isolates the fluid stored inside the tank. The first seal 25 is, for example, interposed between the base 13 and the faucet 2 (for example in a groove).

In the upper part, the chamber 26 may be isolated from the outside ambient air by a second seal 24. The second seal 24 is, for example, interposed between the base 13 and the faucet 2.

As shown, the faucet 2 preferably has at least one bore 23 in fluidic communication with the chamber 26, to evacuate the gas from the gap 14. Preferably, without limiting the invention, the bore(s) 23 forms(form) a circuit for the gas which is separate from the extraction circuit 22 of the faucet 2 by means of which the gas is withdrawn from the tank 1.

Preferably, the circuit formed by the bore(s) 13 comprises an end provided to be in fluidic connection with an evacuation circuit formed in the member 3 for receiving and/or dispensing gas which is connected to the faucet 2. In other words, by being connected to the faucet 2, the member 3 for using gas from the tank or the member 3 providing the filling of the tank preferably recovers the gas from the gap 14.

In other words, the base 13 makes it possible to channel the gas from the gap 14 toward the connection of the tank, the gas then being evacuated, via the faucet 2, by a receiving member 3.

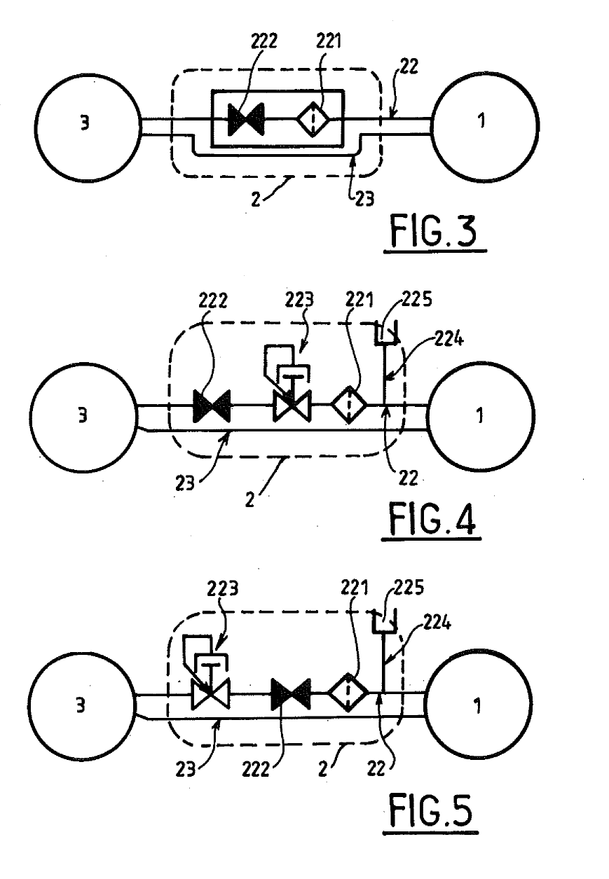

The structure is shown schematically in FIG. 3. The extraction circuit 22 of the faucet 2 makes it possible to extract gas from the tank 1 toward the member 3. The extraction circuit 22 comprises, for example, a flap valve 222 and possibly a filter 221. The circuit 23 makes it possible to evacuate the gas from the gap parallel to the extraction circuit 22. In addition to the emptying of the tank, the circuit 22 may, if required, be also provided to ensure the filling of the tank.

Said embodiment of the faucet 2 makes it possible to facilitate the recovery of gas as a result of permeation from the internal casing 12 by means of a dedicated circuit 23. As shown in FIG. 2, the member 3 is preferably connected to the faucet 2 via a rapid connection interface 29. In this manner, the faucet 2 makes it possible for the emptying 22 and evacuation 23 circuits to be connected in a sealed manner to the respective circuits of the receiving member 3 which, for example, forms part of the consumer application of the gas of the tank.

When the tank 1 is connected to the gas consumer application point, the coaxial rapid connection interface 29 is connected to the receiving member 3. The connection between the member 3 and the faucet 2 comprises, for example, a system with locking elements 291 (for example locking pins) which are mechanically fastened in housings 31 (for example bayonet fittings) so as to prevent the translation of the rapid connection 29 of the faucet 2 relative to the receiving member 3.

The faucet 2 has one end of specific shape provided to be accommodated in a housing adjoined to the member 3.

For example, a first cylindrical portion 292 of the faucet 2 is centered in a bore 32 adjoined to the member 3. A seal 33 carried by the member 3 provides the sealing function and isolates the evacuation circuit E of the gas from the gap 14 relative to the external ambient air.

A second cylindrical portion 293 of the end of the faucet 2 is centered in a second corresponding bore 34 of the member 3. A second seal 35 provides the isolation of the extraction circuit 22 and the evacuation circuit E.

In the connected position, the annular volume located about the second cylindrical portion 293 (and defined between the two seals 33, 35 of the member 3) makes it possible to connect the evacuation circuit 23 of the faucet 2 to an orifice E formed in the receiving member 3. Said orifice provides, therefore, the evacuation of gas as a result of permeation from the internal casing 12. Said permeation gas may thus be controlled in the region of the consumer application point (member 3). For example, said permeation gas is evacuated to the atmosphere in a secure zone or recycled in the consumer application point. The flow rate of said evacuated gas may also be measured.

The extraction channel 22 passes through the body 21 of the faucet 2 and connects the interior of the tank to the end 294 of the coaxial rapid connection interface 29 of the member 3. When the faucet 2 of the tank 1 is connected to the gas consumer application (member 3), the extraction circuit opens into the circuit V of the receiving member 3 provided for the receiver.

In the variant of FIG. 4, a pressure relief member 223 lowering the pressure to a specific value may be incorporated in the extraction circuit 22 upstream of the isolating valve 222 (i.e. on the tank side). As shown, the filling circuit 224 of the faucet 2 may comprise a dedicated filling connector 225 to fill the tank 1. The filling circuit 224 may be separate from the extraction circuit 22 or may comprise a common portion.

As shown in FIG. 5, the pressure relief member 223 may be placed downstream of the isolating member 222 (i.e. on the member side). As above, preferably, a filling circuit 224 with a dedicated connector 225 is provided to fill the tank.

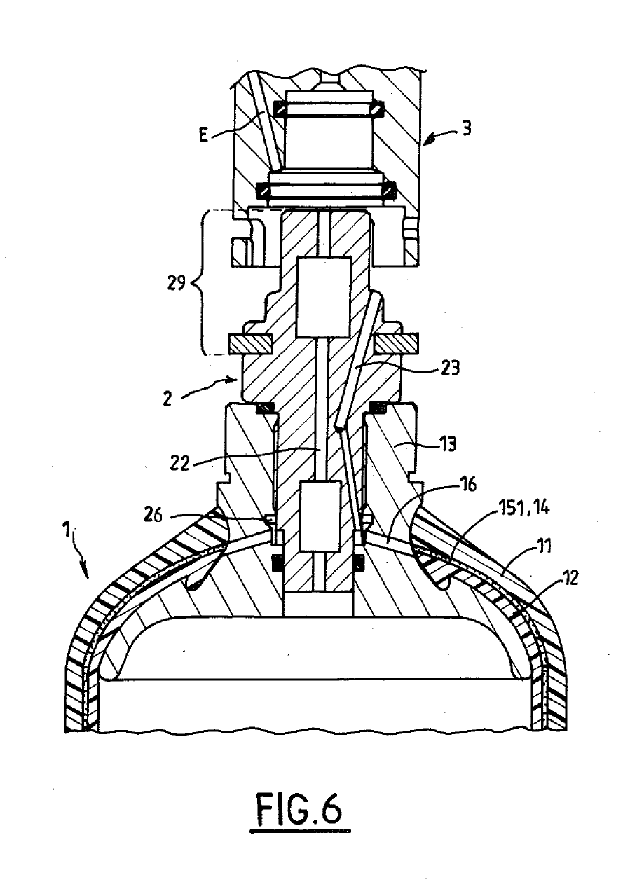

FIG. 6 shows a variant which is distinguished from that of FIG. 2 in that a drainage material 151 is arranged between the internal casing 12 and the external mechanical reinforcement casing 11, so as in particular to maintain a minimum spacing, making it possible to ensure the evacuation flow.

For reasons of concision, elements which are identical to those described above are denoted by the same reference numerals and are not described again.

Said layer of drainage material 151 comprises, for example, a polyurethane foam and/or non-impregnated mineral and/or synthetic fibers or the like.

The drainage material 151 is provided to promote the circulation of the permeation gas trapped in the gap 14 toward the collecting zone 15, then to the evacuation zone (orifices 16 of the base 13, then circuits 23, E, etc.).

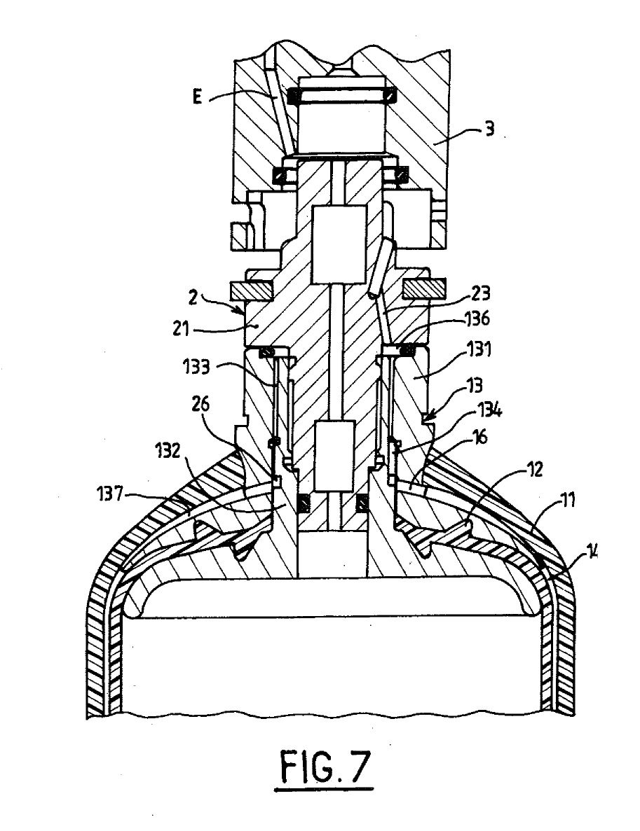

FIG. 7 illustrates a further variant in which the base 13 comprises two parts: a first internal part 132 and a second external part 131. The internal casing 12 of the tank is sandwiched in a sealed manner between said two parts of the base 13 (said configuration has the advantage of permitting the use of adhesive to be avoided).

The internal part 132 of the base 13 may, for example, comprise a thread 133 to which a tapped portion of the external part 131 is screwed.

The external part 131 of the base 13 may comprise one or more collecting grooves 137 for gas trapped in the gap 14. Said grooves 137 direct the gas to the evacuation orifices or conduits 16.

As before, the evacuation conduits 16 may converge toward a chamber 26 (for example an annular chamber). Said chamber 26 communicates with a groove 134 formed in the base 13. For example, the groove 134 is formed in the threaded portion 133 and conducts the gas to a second chamber 136 (for example an annular chamber) formed between the base 13 and the body 21 of the faucet 2. Said second chamber 136 is connected to the evacuation circuit 23 formed in the faucet 2.

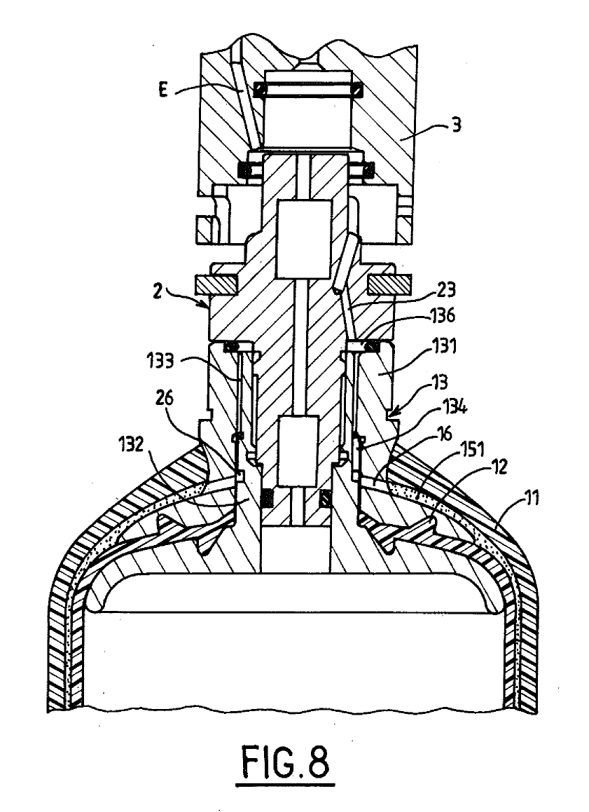

The variant of FIG. 8 is distinguished from that of FIG. 7 in that a layer of drainage material 151 is arranged between the internal casing 12 and the external mechanical reinforcement casing 11. The layer of drainage material 151 (which comprises for example polyurethane foam, non-impregnated mineral or synthetic fibers, etc.) is provided to maintain a minimum spacing in the region of the gap 14, permitting the specific evacuation flow to be ensured.

Thus, it is conceived that the invention, whilst being of simple and inexpensive structure, makes it possible to avoid the undesirable effects of permeation of the composite gas tanks. The invention relates in a particularly advantageous manner to composite tanks of the IV type, for the storage of a gas composed of or comprising hydrogen (at a pressure ranging between 450 and 800 bar, in particular).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A composite pressurized gas tank comprising a sealed internal casing (12) having an opening (18) at one of its ends, a base (13) fixed in the region of the opening (18) of the internal casing (12), the base (13) being adapted to receive or incorporate a valve or faucet, the tank also comprising an external mechanical reinforcement casing (11) arranged on at least one part of the internal casing (12), at least one part of a gap (14) located between the internal casing (12) and the external mechanical reinforcement casing (11) being connected to at least one collecting zone (15) for the gas which is capable of accumulating in said gap (14), the at least one collecting zone (15, 137) opening into a specific evacuation zone (16, 26, 23) outside the gap (14), wherein the collecting zone (15, 137) communicates with at least one volume (26, 135, 134) located inside the body of the base (13), and in that the tank comprises a faucet (2), with or without a pressure relief member, arranged in a sealed manner in the base (13), and in that the evacuation zone comprises a volume or a channel (23) inside the body of the faucet (2).

2. The tank of claim 1, wherein the evacuation zone comprises the atmosphere.

3. The tank of claim 1, wherein the evacuation zone comprises the internal volume of the internal casing (12), the at least one collecting zone (15, 137) opens into the internal volume of the internal casing (12) via a pressure-sensitive flap valve adapted to permit the passage of gas toward the internal volume of the internal casing (12) solely in the event of a specific difference in pressure between the at least one collecting zone (15, 137) and the internal volume of the internal casing (12).

4. The tank of claim 1, wherein the evacuation zone comprises at least one conduit (16) and/or a cavity (26) delimited by the base (13).

5. The tank of claim 1, wherein the base (13) comprises an upper part of generally tubular shape and a lower portion, one part of the surface (121) of the internal casing (12) being in sealed contact with at least one part of a surface (131) of the lower portion of the base (13).

6. The tank of claim 5, wherein at least one collecting zone (15, 137) is formed in the region of the external surface of the portion of the internal casing (12) which is located in the region of the base (13).

7. The tank of claim 5, wherein at least one collecting zone is formed in the region of an external surface (131) of the base (13).

8. The tank of claim 1, wherein the at least one collecting zone comprises at least one groove (15, 137) forming at least one collecting and circulation channel for the gas.

9. The tank of claim 1, wherein the evacuation zone comprises at least one volume (26) located between the body of the base (13) and the body of the faucet (2) arranged in the base (13), said volume (26) being in fluidic communication with the collecting zone (15, 137).

10. The tank of claim 1, wherein the evacuation zone comprises an internal evacuation circuit (23) in the body of the faucet (2), the internal evacuation circuit (23) being in fluidic communication with the collecting zone (15, 137).

11. The tank of claim 10, wherein the faucet (2) comprises an internal extraction circuit (22) and/or an internal filling circuit (22) in fluidic communication with the internal volume of the internal casing (12), the internal evacuation circuit (23) of the faucet (2) being at least partially separate from the extraction circuit (22) and/or the filling circuit (22).

12. An assembly for delivering gas comprising a tank of claim 1 and a member (3) for receiving and/or dispensing gas, comprising an end for selective connection to the faucet (2) to provide a transfer of gas to or from the tank via the faucet (2), wherein the member (3) comprises a circuit for recovering gas which communicates selectively with the evacuation zone when the member (3) is connected to the faucet (2).
